(19) United States
(12) Patent Application Publication
(10) Pub. No.: US 2009/0150531 A1
(43) Pub. Date: Jun. 11, 2009

(54) DATA PROCESSING APPARATUS, CONTROL METHOD THEREFOR, AND STORAGE MEDIUM

(75) Inventors: Kenji Hara, Kawasaki-shi (JP); Toshihisa Okutsu, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/329,297

(22) Filed: Dec. 5, 2008

(30) Foreign Application Priority Data
Dec. 7, 2007 (JP) 2007-317280

(51) Int. Cl. G06F 15/177

(52) U.S. Cl. 709/222

(57) ABSTRACT

A data processing apparatus includes a data storage unit configured to store data, an information storage unit configured to store identification information of an apparatus that has set a link to the data stored in the data storage unit and information indicating a link type of the link, a reception unit configured to receive a link request for setting a link to the data stored in the data storage unit from another data processing apparatus, a setting unit configured to set the link to the data stored in the data storage unit based on the link request received by the reception unit, and a sending unit configured to send the information stored in the information storage unit to the another data processing apparatus according to the link being set by the setting unit.

### BACKGROUND OF THE INVENTION

1. Field of the Invention

The present invention relates to a data processing apparatus, more specifically, a function for providing data stored therein to other apparatuses, a control method therefor, and a storage medium storing a computer program.

2. Description of the Related Art

With the recent development of network technology, a large number of data processing apparatuses are often connected to a network. In a system that utilizes the network, each apparatus on the network stores various data. For example, in such a system, a HyperText Transport Protocol (HTTP) server stores data described in a HyperText Markup Language (HTML). In this case, an apparatus different from the data processing apparatus, namely, a personal computer (PC), for example, accesses the HTTP server via the network using a World Wide Web (WWW) browser to refer to data stored in the HTTP server.

With respect to a network resource, a “link” is defined. Here, the “link” refers to an access to an entity of desired data by accessing an apparatus (for example, a server) that stores the desired data according to location information associated with the data.

The “location information” refers to network address information necessary to access the server and information indicating a data storage location in the server.

The link enables reducing the amount of data to be stored on the PC and virtually displaying information as if a plurality of data entities exists

In addition, a conventional digital multifunction peripheral (MFP) includes a file server function. The digital MFP reads an image of a document and stores the read document image on a memory. Furthermore, the digital MFP reads the document image from the memory as necessary and prints the read document image.

As the memory device that stores a read image, a hard disk drive (HDD) is often used. However, an HDD has a limited data storage capacity. Accordingly, the amount of information that can be stored on an HDD of an apparatus is limited. In this regard, such a conventional method has been discussed that in a system including a plurality of digital MFPs in communication with one another via a network, it is virtually displayed as if one digital MFP stores a large number of document files.

The method like this is called a “network distributed storage management method”. In this method, a link type is used that enables the reference of a document file stored in each digital MFP from either of the other MFPs.

The link type includes two link types, namely, a “hard link” and a “soft link”.

For example, suppose that in a system, a digital MFP that stores the entity (the original) of data, among the digital MFPs connected via the network, serves as an access destination apparatus while a different other digital MFP that refers to the data stored in the access destination apparatus, among the digital MFPs connected via the network, serves as an access source apparatus.

In the above-described system, in the case of the hard link, the access source apparatus stores a copy of the entity of the data stored in the access destination apparatus. In referring to the data, the access source apparatus refers to the copy of the data.

In this regard, in the case of the soft link, the access source apparatus stores the address information and the data storage location information about the access destination apparatus but does not store a copy of the entity of the data.

Accordingly, in referring to the entity of the data, the access source apparatus accesses the entity of the data in the access destination apparatus according to the address information and location information of the data.

In the case of the above-described hard link, an access to the data can be performed at a high processing speed since the data obtained by copying the original exists in the access source apparatus. However, the access source apparatus requires a storage resource, such as an HDD, for storing the copy data. On the other hand, in the case of the soft link, the access source apparatus does not store the data itself. Accordingly, in this case, the access source apparatus does not require a mass storage resource, such as an HDD.

However, in the case of using the soft link, the access source apparatus cannot refer to the data stored in the access destination apparatus if a failure has occurred in the access destination apparatus, if the access destination apparatus has been powered off, or if a network communication is not available. This is generally called a problem of “dead link” (“broken link”).

In order to solve a problem like this, Japanese Patent Application Laid-Open No. 2004-078789 discusses a method in which a dedicated alternative server for storing the same data as that stored in an access destination apparatus (a server) is provided in addition to the server to provide a plurality of entities of the data.

According to the method discussed in Japanese Patent Application Laid-Open No. 2004-078789, the access source apparatus can refer to the data by accessing the alternative server when the server, which is the access destination apparatus, cannot provide the data due to any cause. On the other hand, in the conventional method, it is necessary to provide a dedicated alternative server.

In the case where all of the access source apparatuses use the hard link, it is not necessary to provide an alternative server. In addition, if at least one specific access source apparatus that uses the hard link is provided, the access source apparatus can serve as the alternative server.

As described above, in an environment in which either the hard link or the soft link is selectively available as the link type, the dedicated alternative server may be useless according to the configuration and status of the system.

Furthermore, in this regard, each access source apparatus cannot recognize the status as to which link type has been set with respect to arbitrary data stored in the access destination apparatus. Accordingly, whether it is necessary to provide an alternative server cannot be determined in this case. Thus, in the above-described conventional method, each access source apparatus cannot effectively cope with the problem of broken link.

### SUMMARY OF THE INVENTION

An embodiment of the present invention is directed to a data processing apparatus capable of allowing an access source apparatus to effectively cope with a problem of broken link.

According to an aspect of the present invention, a data processing apparatus includes a data storage unit configured to store data, an information storage unit configured to store identification information of an apparatus that has set a link to the data stored in the data storage unit and information indicating a link type of the link, a reception unit configured to receive a link request for setting a link to the data stored in the data storage unit from another data processing apparatus, a setting unit configured to set the link to the data stored in the data storage unit based on the link request received by the reception unit, and a sending unit configured to send the information stored in the information storage unit to the another data processing apparatus according to the link being set by the setting unit.

According to another aspect of the present invention, a method for controlling a data processing apparatus includes storing data in a data storage unit, storing identification information of an apparatus that has set a link to the data stored in the data storage unit and information indicating a link type of the link, receiving a link request for setting a link to the data stored in the data storage unit from another data processing apparatus, setting the link to the data stored in the data storage unit based on the received link request, and sending the stored information to the another data processing apparatus according to the link being set.

According to yet another aspect of the present invention, a computer-readable storage medium stores instructions which, when executed by a data processing apparatus, cause the data processing apparatus to perform operations including storing data in a data storage unit, storing identification information of an apparatus that has set a link to the data stored in the data storage unit and information indicating a link type of the link, receiving a link request for setting a link to the data stored in the data storage unit from another data processing apparatus, setting the link to the data stored in the data storage unit based on the received link request, and sending the stored information to the another data processing apparatus according to the link being set.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the present invention.

FIG. 1 illustrates an exemplary configuration of a file system according to an exemplary embodiment of the present invention.

FIG. 2 illustrates an example of an operation unit of a digital MFP according to the exemplary embodiment of the present invention.

FIG. 3 illustrates an example of a user interface screen of a digital MFP according to the exemplary embodiment of the present invention.

FIGS. 4A to 4C each illustrate an example of a user interface screen of a digital MFP according to the exemplary embodiment of the present invention.

FIG. 5 illustrates an exemplary data structure of a box of a digital MFP according to the exemplary embodiment of the present invention.

FIG. 6 illustrates an exemplary data structure of a box of a digital MFP according to the exemplary embodiment of the present invention.

FIG. 7 illustrates an example of link information that a digital MFP stores according to the exemplary embodiment of the present invention.

FIGS. 8A and 8B each illustrate an example of a user interface screen of a digital MFP according to the exemplary embodiment of the present invention.

FIG. 9 illustrates an exemplary data structure of a box of a digital MFP according to the exemplary embodiment of the present invention.

FIG. 10 illustrates types of icons, each of which is displayed according to a document stored in a box according to the exemplary embodiment of the present invention.

FIG. 11 is a flowchart that illustrates an example of an operation performed by a digital MFP according to a first exemplary embodiment of the present invention.

FIG. 12 is a flowchart that illustrates an example of an operation performed by a digital MFP according to the first exemplary embodiment of the present invention.

FIG. 13 illustrates an example of a user interface screen of a digital MFP according to a second exemplary embodiment of the present invention.

FIG. 14 is a flowchart that illustrates an example of an operation performed by a digital MFP according to the second exemplary embodiment of the present invention.

FIG. 15 is a flowchart that illustrates an example of an operation performed by a digital MFP according to a third exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

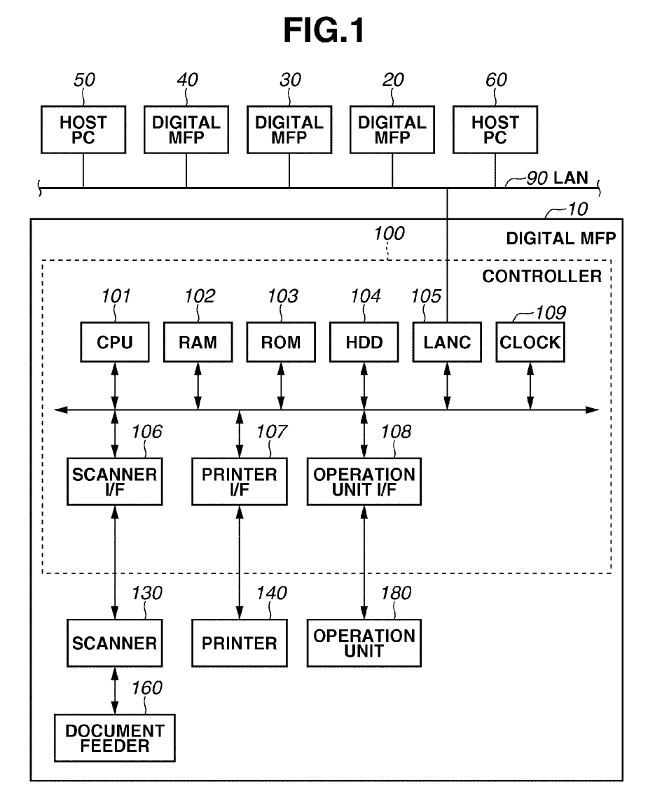

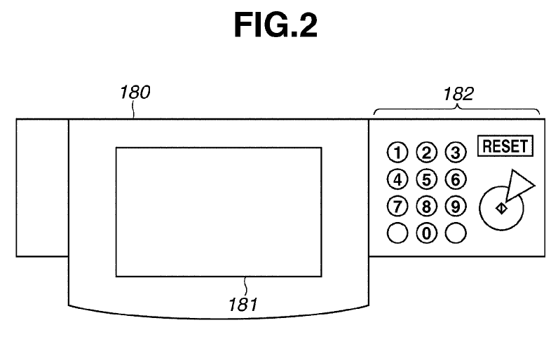

A first exemplary embodiment of the present invention will now be described below. FIG. 1 illustrates an exemplary configuration of a file system according to the first exemplary embodiment of the present invention. FIG. 2 illustrates an exemplary configuration of an operation unit of a digital MFP 10 illustrated in FIG. 1.

The file system according to the present exemplary embodiment can share at least one file among a plurality of digital MFPs 10, 20, 30, and 40 as illustrated in FIG. 1. Each of the digital MFPs 10, 20, 30, and 40 is connected to a network, such as a local area network (LAN) 90. In addition, a plurality of host PCs 50 and 60 is connected to the LAN 90.

Each of the digital MFPs 10 through 40 includes a function for inputting and outputting an image. For example, each of the digital MFPs 10 through 40 reads an image of a document and inputs image data of the read image. Furthermore, each of the digital MFPs 10 through 40 can input the image data sent from another apparatus on the LAN 90.

In addition, each of the digital MFPs 10 through 40 stores the input image data and prints the image data on recording paper. Furthermore, each of the digital MFPs 10 through 40 can transfer the image data to other apparatuses via the LAN 90.

In the example illustrated in FIG. 1, the digital MFP 10 has the following configuration. That is, the digital MFP 10 includes a controller 100. The controller 100 is connected to a scanner 130 and a printer 140. The controller 100 controls an operation of the scanner 130 and the printer 140.

Furthermore, the controller 100 is connected to the LAN 90. The controller 100 controls the input and output of image data and device information performed via the LAN 90.

The controller 100 includes a central processing unit (CPU) 101, a random access memory (RAM) 102, a read-only memory (ROM) 103, an HDD 104, and a LAN controller (LANC) 105. In addition, the controller 100 includes a scanner interface (I/F) 106, a printer I/F 107, an operation unit I/F 108, and a clock 109. These components are in communication with one another via a system bus 120.

The CPU 101 controls the input and output of the image data and the device information according to a program stored on the ROM 103 or the HDD 104. In addition, the CPU 101 controls each component connected to the system bus 120 according to a program stored on the ROM 103 or the HDD 104.

The RAM 102 provides a work area for the CPU 101. The HDD 104 stores a program and image data.

The LAN controller 105 is connected to the LAN 90. The LAN controller 105 inputs and outputs image data and device information with an apparatus connected on the LAN 90.

The scanner I/F 106 is an interface between the CPU 101 and the scanner 130. The scanner I/F 106 controls data communication between the scanner 130 and the CPU 101. Here, the scanner 130 includes a document feeder 160, which serially feeds a plurality of documents to the scanner 130. The scanner 130 reads the document fed by the document feeder 160.

The printer I/F 107 is an interface between the CPU 101 and the printer 140. The printer I/F 107 controls data communication between the CPU 101 and the printer 140. The printer 140 performs printing according to the input image data. The printer 140 includes a laser beam printer or an ink-jet printer.

The operation unit I/F 108 controls data communication between the CPU 101 and an operation unit 180. The operation unit 180 includes keys 182 and a liquid crystal display (LCD) panel 181, for example, as illustrated in FIG. 2. The keys 182 includes a plurality of hard keys that can be operated by a user to input various setting information. The LCD panel 181 displays a content of the setting by the user and status information about the apparatus. Furthermore, the LCD panel 181 can display soft keys that can be operated by a user to perform various settings.

The information input by the user by operating the operation unit 180 is sent to the CPU 101 via the operation unit I/F 108. The CPU 101 performs corresponding processing according to the input information. Furthermore, the operation unit 180 displays information input from the CPU 101 via the operation unit I/F 108 on the LCD panel 181.

The clock 109 provides date and time information. A battery (not illustrated) is used to provide backup power to the clock 109 as power therefor after the apparatus is powered off.

In the present exemplary embodiment, each of the other digital MFPs, namely, the digital MFPs 20 through 40, includes a configuration similar to that of the digital MFP 10. Accordingly, the description thereof will not be repeated here.

In the present exemplary embodiment, a reference target file (hereinafter simply referred to as the “data”) stored in the digital MFP 10 can be referred to from the digital MFPs 20 through 40 by using a link type set by the user. Here, the link type set by the user includes the soft link and the hard link.

The soft link (a first link type) is a link type for referring to the data by directly accessing the data stored in the digital MFP 10 from the digital MFPs 20 through 40 via the LAN 90. The hard link (a second link type) is a link type with which the digital MFPs 20 through 40 store a copy of the data to refer to the copy of the stored data.

The data stored in the digital MFP 10 can be referred to by each of the digital MFPs 20 through 40 by using the soft link or the hard link. In this regard, the digital MFP 10 stores link node information, which is information used for managing which link type has been used for referring to the data by the digital MFPs 20 through 40.

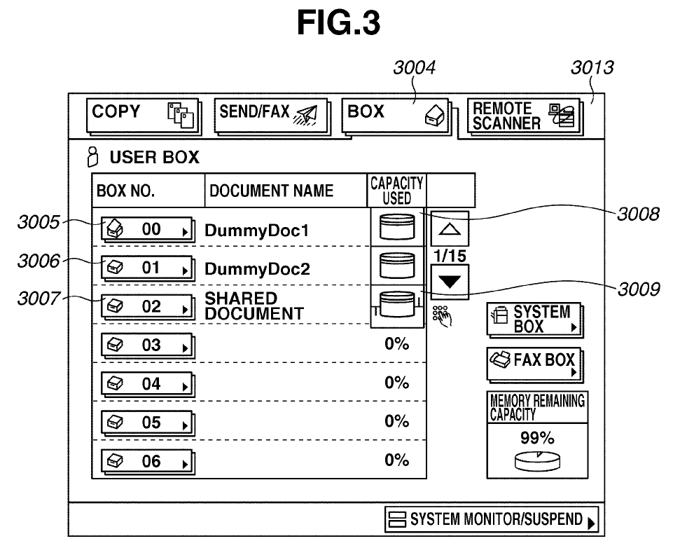

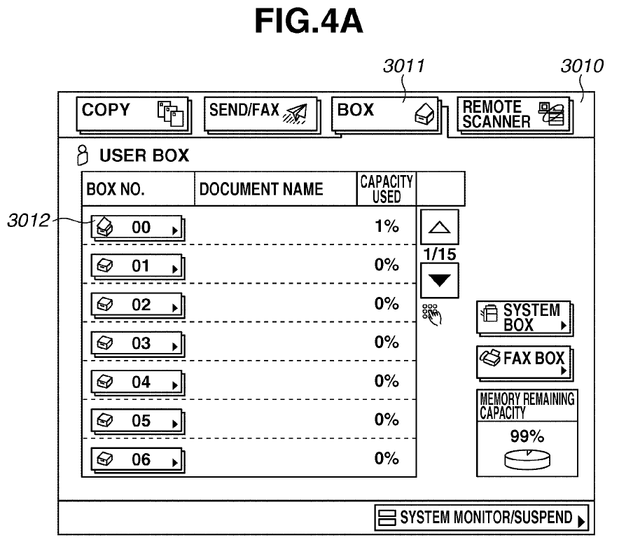

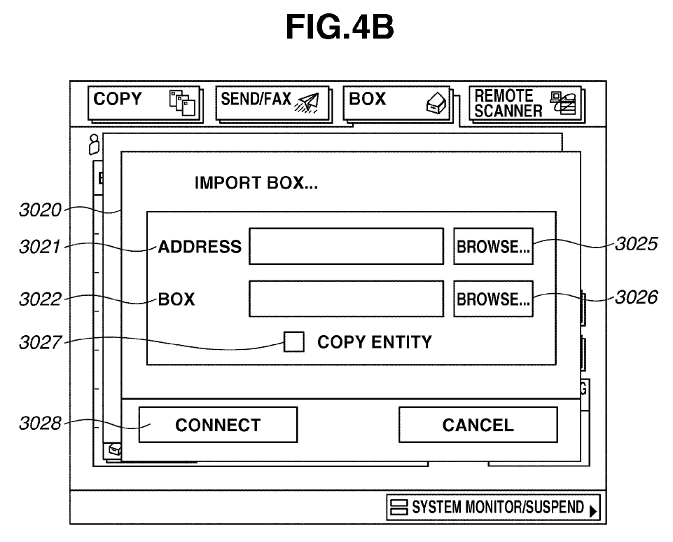

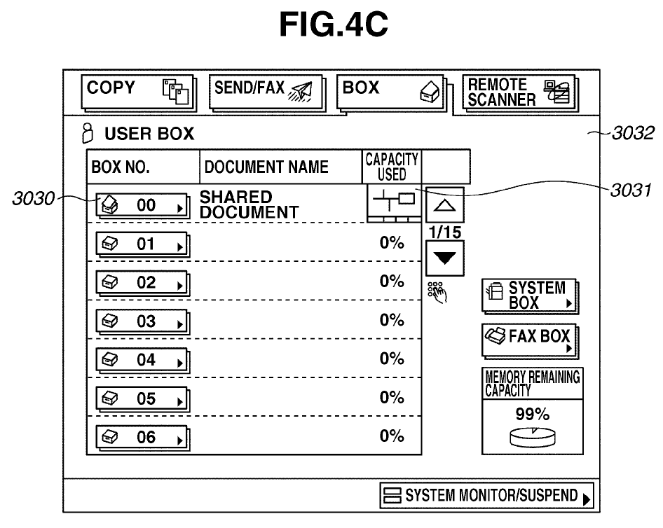

Now, a setting for the link type for referring to the data stored in the digital MFP 10 from the digital MFPs 20 through 40 is described with reference to FIG. 3 and FIGS. 4A through 4C.

FIG. 3 illustrates an example of a user interface screen of the digital MFP 10, which stores the data, according to the present exemplary embodiment. FIGS. 4A through 4C each illustrate an example of a user interface screen of the digital MFP 20 according to the present exemplary embodiment.

In the digital MFP 10, a user interface screen 3013 illustrated in FIG. 3, for example, is displayed on the LCD panel 181 of the operation unit 180 as a user interface screen for selecting a desired function from among a plurality of functions of the digital MFP 10.

Here, in selecting a box function, the user selects a “box” tab 3004, which is provided on the user interface screen 3013. Thus, a box selection screen is displayed on the LCD panel 181.

On the box selection screen, buttons 3005 through 3007 are displayed. More specifically, the button 3005 corresponds to a box whose box number is “00”. The button 3006 corresponds to a box whose box number is “01”. The button 3007 corresponds to a box whose box number is “02”. Each box is provided in a predetermined storage area on the HDD 104.

The box stores image data obtained by reading an image of a document with the scanner 130 and data input by the host PCs 50 and 60 via the LANC 105. The data stored in the box can be printed with the printer 140 or transmitted to the network via the LANC 105.

On the box selection screen, an icon that indicates a document name and a storage destination of a document that is the data stored in the box is displayed in correspondence with each button. Here, with respect to an icon for a document that is not referred to from the digital MFPs 20 through 40, the icon indicates that the document can be accessed from only the digital MFP 10. On the other hand, in the case where the document stored in the box of the digital MFP 10 is a shared document, the icon for the shared document indicates that the document can be accessed from the digital MFPs 20 through 40 via the LAN 90.

For example, on the box selection screen, with respect to the box of the digital MFP 10 whose box number is “00”, a document name “dummyDoc1” stored in the box “00” is displayed, for example. As the icon for the document “dummyDoc1”, an icon 3008 is displayed. The icon 3008 indicates that the storage destination of the document is the HDD 104 of the digital MFP 10 and that the document “dummyDoc1” cannot be accessed from the digital MFPs 20 through 40.

Furthermore, with respect to the box whose box number is “02”, a document name “shared document” of the document stored in the box “02” is displayed on the box selection screen. As the icon for the document “shared document”, an icon 3009 is displayed. The icon 3009 indicates that the storage destination of the document “shared document” is the HDD 104 of the digital MFP 10 and that the document “shared document” can be accessed from the digital MFPs 20 through 40.

When the user presses the button corresponding to the desired box on the box selection screen, the box is selected. In this state, the user can read the document stored in the box. Furthermore, the user can store the desired document in the selected box.

In the digital MFP 20, a user interface screen 3010 illustrated in FIG. 4A is displayed on the LCD panel 181 of the operation unit 180, as in the digital MFP 10. When the user selects a “box” tab 3011 via the user interface screen 3010, the box selection screen is displayed on the LCD panel 181. A configuration of the box selection screen of the digital MFP 20 is similar to the configuration of the box selection screen of the digital MFP 10.

Here, suppose that the user has set the soft link as the link type for referring to the shared document stored in the box of the digital MFP 10 whose box number is “02” from the digital MFP 20. In this case, as the box of the digital MFP 20 virtually storing the shared document, the box of the digital MFP 20 whose box number is “00” is designated.

At first, the user presses the button 3012 corresponding to the box whose box number is “00” on the box selection screen of the digital MFP 20. Here, the box whose box number is “00” is currently empty because no document has been currently stored therein.

When the user presses the button 3012, a “box import” button (not illustrated) is displayed. When the user presses the “box import” button, an “import box” screen 3020 illustrated in FIG. 4B is displayed.

An address information entry field 3021 and a box number entry field 3022 are provided on the “import box” screen 3020. Address information for a node to be imported is entered in the address information entry field 3021. The box number of the box is entered in the box number entry field 3022.

In the address information entry field 3021, the address information about the digital MFP 10 “168.10.1.1”, for example, is entered. On the other hand, the box number of the box of the digital MFP 10, namely, the box number “02” in this case, is entered in the box number entry field 3022.

Note that the address information about the digital MFP 10is not limited to an Internet protocol (IP) address. That is, a value that can identify an apparatus such as a media access control (MAC) address or a host name can be used as the address information about the digital MFP 10 instead of the IP address.

Furthermore, browse buttons 3025 and 3026 are provided on the “import box” screen 3020. The browse buttons 3025 and 3026 can be operated by the user to refer to each of the address information entered in the address information entry field 3021 and the box number entered in the box number entry field 3022.

Furthermore, a check box 3027 is provided on the “import box” screen 3020. The check box 3027 can be operated by the user to select whether to copy the entity (the original document) of the shared document at the time of setting the link type. In the present exemplary embodiment, the soft link is set as the link type instead of marking the check box 3027. On the other hand, when the hard link is set as the link type, the check box 3027 is marked.

After performing the operation for setting the soft link as the link type for referring to the shared document stored in the digital MFP 10 as described above, the user presses a “connect” button 3028. Thus, the digital MFP 20 sends a link request to the digital MFP 10.

The link request includes identification information of the digital MFP 20, information about a path to the data to be linked, and the link type (here, the soft link). The “path information” is information including the name of the apparatus that stores the data, the number of the box storing the data, and a file name.

After receiving the link request, the digital MFP 10 sends information corresponding to the link type to the digital MFP 20. Here, since the soft link has been set as the link type, the digital MFP 10 sends the link node information managed with the shared document to the digital MFP 20.

The digital MFP 20 displays a screen 3032 illustrated in FIG. 4C on the operation unit 180 according to the link node information sent from the digital MFP 10.

The screen 3032 displays the name of the shared document that is associated with and corresponds to a button 3030. Here, the button 3030 corresponds to the box whose box number is “00”. In this state, it is indicated that the shared document is stored in the box whose box number is “00”. When the user presses the button 3030, the user can read the shared document from the box whose box number is “00”.

Here, in the case of the soft link, in the box whose box number is “00”, the address information about the digital MFP 10 and the path information of the data are stored as the link information, instead of storing therein the entity of the data of the shared document. Accordingly, in the box of the digital MFP 10 whose box number is “02”, the shared document is virtually stored.

In order to indicate the above-described state and information, an icon 3031, which is associated with and corresponds to the button 3030, is displayed. The icon 3031 indicates that the storage destination of the shared document is the HDD 104 of the digital MFP 10 and that the digital MFP 20 can access the HDD 104.

The soft link is the link type for accessing the document stored in the access destination apparatus (the digital MFP 10) via the LAN 90 from the access source apparatus (the digital MFP 20). Accordingly, the soft link has an effect for enabling reducing the necessary capacity of the storage device (a local storage), such as an HDD, of the access source apparatus.

That is, the digital MFP 20 can register a large number of documents regardless of the capacity of the local storage. Furthermore, an access source apparatus having no local storage can share the document.

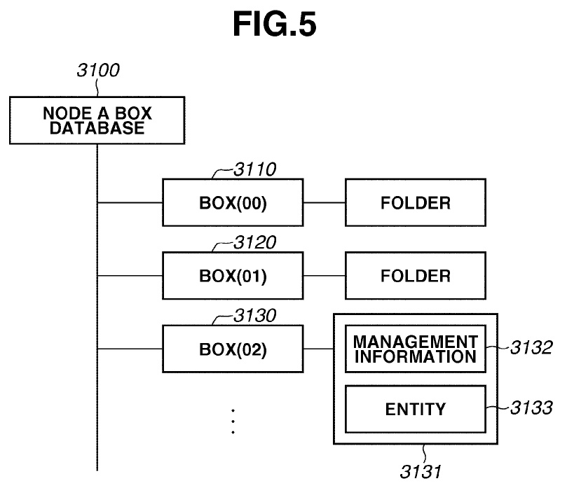

Now, an exemplary data structure of the box of the digital MFP 10 whose box number is “02” is described with reference to FIG. 5. FIG. 5 illustrates an exemplary data structure of the box of the digital MFP 10 whose box number is “02” according to the present exemplary embodiment.

In the digital MFP 10, each of boxes 3110, 3120, 3130, and the like is provided within the HDD 104 as a box database 3100 for a node A having a hierarchical structure as illustrated in FIG. 5. Here, the box 3130 is the box whose box number is “02” storing the shared document.

The box 3130 includes a folder 3131. In the folder 3131, management information 3132 for managing the data stored in the box 3130 (here, the shared document) and the data entity 3133 of the shared document are stored.

The management information 3132 includes various information, such as the link node information, the document name of the stored document, a password required to access the box, and an effective period of time left until a time for automatically erasing the data in the box comes. In addition, the management information 3132 includes information indicating whether the link to the data in the box is to be permitted.

Now, the link node information will be described in more detail below. The link node information is information indicating a setting status of the link to the data stored in the box. The link node information includes identification information indicating the apparatus (the node) that has set the link to the data stored in the box and information indicating the link type.

The identification information is information such as an IP address or a host name. The information indicating the link type is information indicating either the soft link or the hard link.

Furthermore, in the case where the hard link has been set as the link type, information about the linked box of the apparatus that has set the link is included in the link node information. In the case where a plurality of apparatuses has set the link, the apparatus to which the link has been set (link receiving apparatus) manages the above-described various information for each of the apparatuses that have set the link thereto.

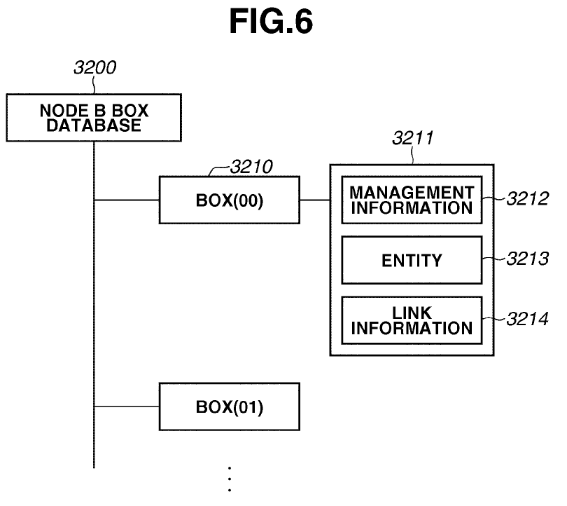

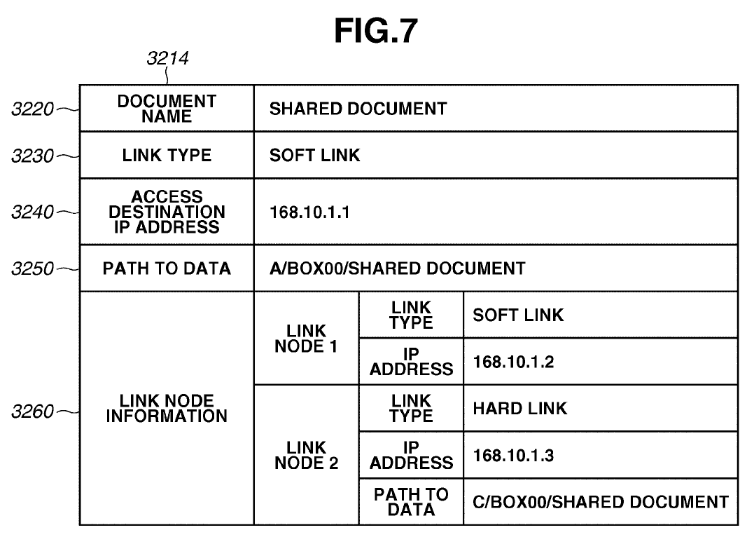

An exemplary data structure of the box of the digital MFP 20 whose box number is “00” in which the shared document is virtually stored by the soft link is described with reference to FIG. 6 and FIG. 7. FIG. 6 illustrates an exemplary data structure of the box of the digital MFP 20 whose box number is “00”. FIG. 7 illustrates an exemplary configuration of the link information stored in the box of the digital MFP 20 whose box number is “00”.

In the digital MFP 20, a box 3210 (the box whose box number is “00”) is provided within the HDD 104 as a box database 3200 for a node B having a hierarchical structure as illustrated in FIG. 6.

The box 3210 includes a folder 3211. In the folder 3211, management information 3212 and a data entity 3213 are stored, as in the folder 3131 illustrated in FIG. 5.

Furthermore, unlike the folder 3131 illustrated in FIG. 5, link information 3214 is stored in the folder 3211. The management information 3212 includes various information, such as the link node information, the document name, a password, and an effective period, similar to the management information 3132 illustrated in FIG. 5.

In this regard, since the soft link has been set for the box number “00” of the digital MFP 20, the link node information is “null”. Furthermore, since the data entity 3213 stores no data, the entity 3213 is “null”.

Now, the link information 3214 will be described in detail below. FIG. 7 illustrates an example of a content of the link information 3214 according to the present exemplary embodiment. The link information is generated when the link to the data in the other apparatus has been set with respect to an arbitrary box. Accordingly, information about the set link is described in the link information.

A name of a link target document is described as a document name 3220. In the example illustrated in FIG. 7, the digital MFP 20 has set the link to the document name “shared document” in the digital MFP 10. Accordingly, the document name “shared document” is described as a document name 3220.

In a link type 3230, information as to which of the link types, namely, the soft link and the hard link, has been set is described. The address information for the link destination apparatus is described in the access destination IP address 3240.

In the example illustrated in FIG. 7, the IP address “168.10.1.1” of the digital MFP 10, which is the link destination apparatus, is described. Path information to the link target data is described in a data path 3250. In the present exemplary embodiment, the path information to the link target data indicates the host name, the box number, and the file name.

Furthermore, link node information 3260 is included in the link information 3214. The “link node information” is information included in the management information 3132 in the digital MFP 10. The “link node information” is information indicating the setting status of the link to the data stored in the box.

After requesting setting the link to the digital MFP 10, the digital MFP 20 receives the link node information from the digital MFP 10. In the example illustrated in FIG. 7, two apparatuses have currently set the link to the shared document in the digital MFP 10.

One apparatus (the first apparatus) has the IP address “168.10.1.2” and sets the link by the soft link. The other apparatus (the second apparatus) has the IP address “168.10.1.3” and sets the link by the hard link. The second apparatus stores therein a copy of the data of the shared document in the box whose box number is “00”.

In referring to the shared document, the digital MFP 20 reads the link information 3214. Thus, the digital MFP 20 can refer to the management information such as the name of the shared document.

Furthermore, the digital MFP 20 accesses the shared document in the digital MFP 10 based on the link information 3214. Thus, the shared document can be referred to from the digital MFP 20.

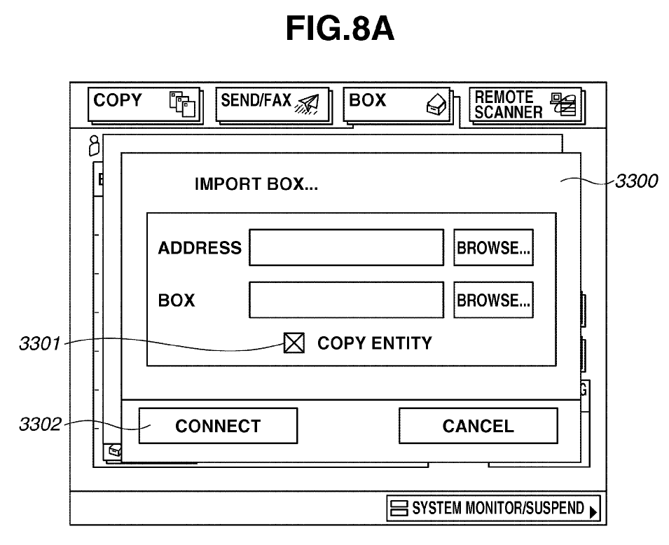

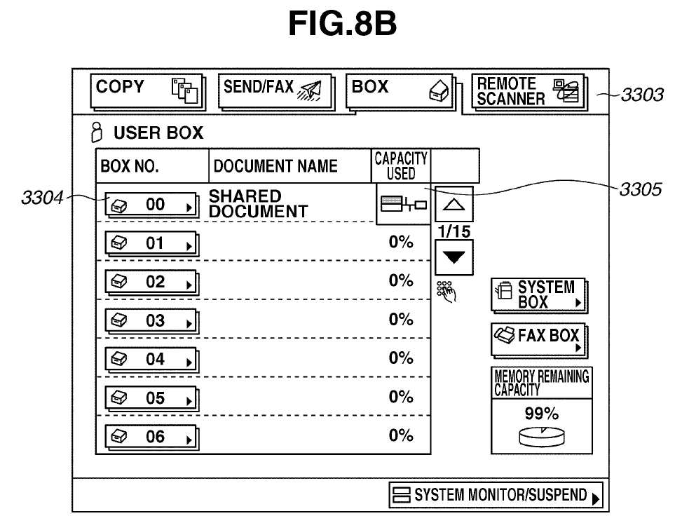

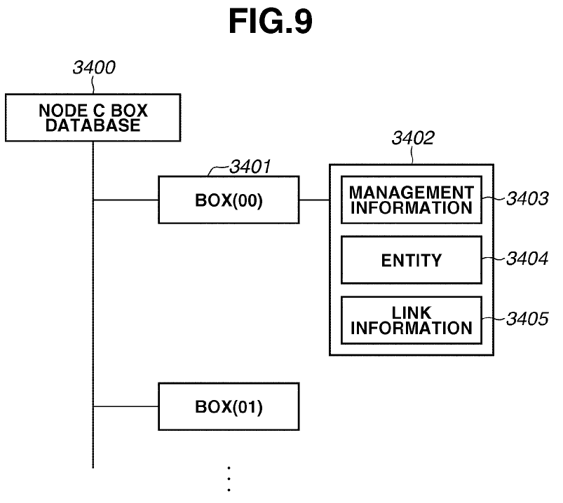

Now, the hard link will be described in detail below with reference to FIGS. 8A and 8B and FIG. 9. FIGS. 8A and 8B each illustrate an example of a user interface screen of the digital MFP 30 according to the present exemplary embodiment. FIG. 9 illustrates an exemplary data structure of the box whose box number is “00” of the digital MFP 30 according to the present exemplary embodiment.

In referring to the shared document stored in the box of the digital MFP 10 whose box number is “02” by the hard link, the digital MFP 30 sets the hard link. In this case, the user performs an operation similar to the operation for setting the soft link by the digital MFP 20.

When an “import box” screen 3300 is illustrated in FIG. 8A is displayed by this operation, the address information for the node that imports the box and the box number of the box of the node are entered by the user. In setting the hard link, the user marks a check box 3301 for selecting whether a file entity (the original document) is to be copied at the time of issuing the link request.

Thus, the digital MFP 30 sets the hard link as the link type for referring to the shared document stored in the box of the digital MFP 10 whose box number is “02”. After that, the user presses a “connect” button 3302.

In this manner, the link request is sent from the digital MFP 30 to the digital MFP 10. Furthermore, according to information sent from the digital MFP 10 as a reply to the link request, the copy of the entity of the shared document is stored in the box whose box number is “00”.

Then, according to the management information, a screen 3303 illustrated in FIG. 8B is displayed on the operation unit 180 of the digital MFP 30. The screen 3303 displays the name of the shared document, which is associated with and corresponds to a button 3304 corresponding to the box whose box number is “00”.

Here, the copy of the entity of the shared document is stored in the box whose box number is “00” because the check box 3301 has been marked. When the user presses the button 3304 in this state, the user can read the shared document (the copy) from the box whose box number is “00”. Furthermore, an icon 3305 is displayed on the screen 3303, which is associated with and corresponds to the button 3304 and indicates that the shared document in the digital MFP 30 can be referred to by the hard link.

In the digital MFP 30, a box 3401 (the box whose box number is “00”) is provided within the HDD 104 as a box database 3400 for a node C having a hierarchical structure as illustrated in FIG. 9. The box 3401 includes a folder 3402.

The folder 3402 stores management information 3403, an entity 3404 of the shared document, and link information 3405, similar to the folder 3211 illustrated in FIG. 6. The entity 3404 is a copy of the entity 3132 in the box 3130.

As described above, the hard link is the link type for storing the entity of the copied document and managing the link information about the original of the document.

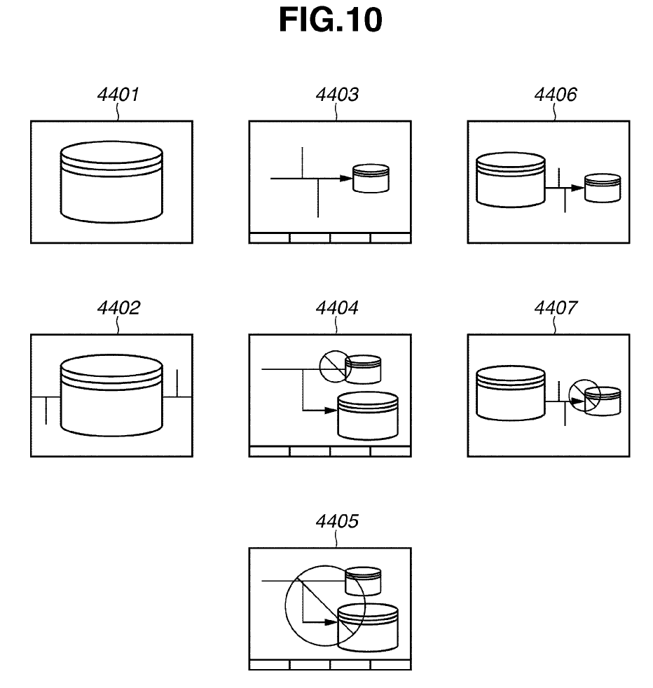

Now, an icon displayed in association with the document stored in the box is described in detail below with reference to FIG. 10. FIG. 10 illustrates an example of a type of the icon displayed in association with the document stored in the box according to the present exemplary embodiment.

In the present exemplary embodiment, it is important to expressly indicate whether the document stored in the box of each of the digital MFPs 10 through 40 is the original or the document linked by the soft link or the hard link.

In the network distributed storage system, if a document is copied repeatedly and at random, various problems may occur such that the data cannot further be erased or that latest updated data cannot be surely accessed, as in the case of the peer-to-peer connection. In terms of managing a document, if such a problem occurs, the document management has been “failed” because the document cannot be appropriately managed in this case.

In order to prevent such a failure, the present exemplary embodiment displays the icon corresponding to the box. As described above, the present exemplary embodiment expressly indicates in what state the document is stored and exists in the box to increase and improve the reliability and the security of the data.

The icon displayed in association with the document in the box includes various icons 4401 through 4407 as illustrated in FIG. 10. The icon 4401 indicates that the corresponding document is the original and that the document cannot be referred to from the other apparatuses on the LAN 90.

Here, if the document in the box is erased, the document is completely erased from the LAN 90. The icon 3008 illustrated in FIG. 3 is equivalent to the icon 4401, for example.

The icon 4402 is the icon for the soft link. The icon 4402 indicates that the corresponding document is the original and that the document can be referred to from the other apparatuses on the LAN 90. Here, if the document is erased, then the document cannot be referred to from the other apparatuses. The icon 3009 illustrated in FIG. 3 is equivalent to the icon 4402, for example.

The icon 4403 is the icon for the soft link. The icon 4403 indicates that in referring to the document, the apparatus accesses the apparatus that stores the entity of the document based on the link information. The icon 3031 illustrated in FIG. 4C is equivalent to the icon 4403, for example.

The icon 4404 is the icon for the soft link. The icon 4404 indicates that the document stored in the corresponding box is not the entity and that the apparatus that stores the entity (the original) of the document cannot be accessed in referring to the document.

In addition, the icon 4404 indicates that the apparatus storing the alternative document for the original can be accessed. More specifically, the icon 4404 indicates that the original cannot be accessed but the alternative document for the original can be accessed.

The icon 4405 is the icon for the soft link. The icon 4405 indicates that the document stored in the corresponding box is not the entity and that the apparatus storing the entity of the document cannot be accessed in referring to the document.

Furthermore, the icon 4405 indicates that the apparatus storing the alternative document for the original cannot be accessed. That is, the icon 4405 indicates that the original and the alternative document for the original cannot be accessed and that the user cannot designate the document stored in the box corresponding to the icon 4405 as a document to be processed in a job.

The icon 4406 is the icon for the hard link. The icon 4406 indicates that the entity of the document stored in the corresponding box is a copy of the entity of the original. For example, the icon 3305 illustrated in FIG. 8B is equivalent to the icon 4406.

The icon 4407 is the icon for the hard link. The icon 4407 indicates that the copied document is stored in the corresponding box and that the apparatus storing the original of the document cannot be accessed.

In the case where the icon 4407 is displayed, it is indicated that the user can designate the document stored in the box as the document to be processed in a job and that the apparatus storing the original of the document cannot be accessed. In this case, the version of the document stored in the box may not have been updated to its latest version.

The above-described various icons are mere examples and the present exemplary embodiment is not limited to them. That is, for the above-described icon, an icon that can expressly indicate in what state the document in the box exists therein. More specifically, a text, an identification mark, or a symbol can be used as the icon.

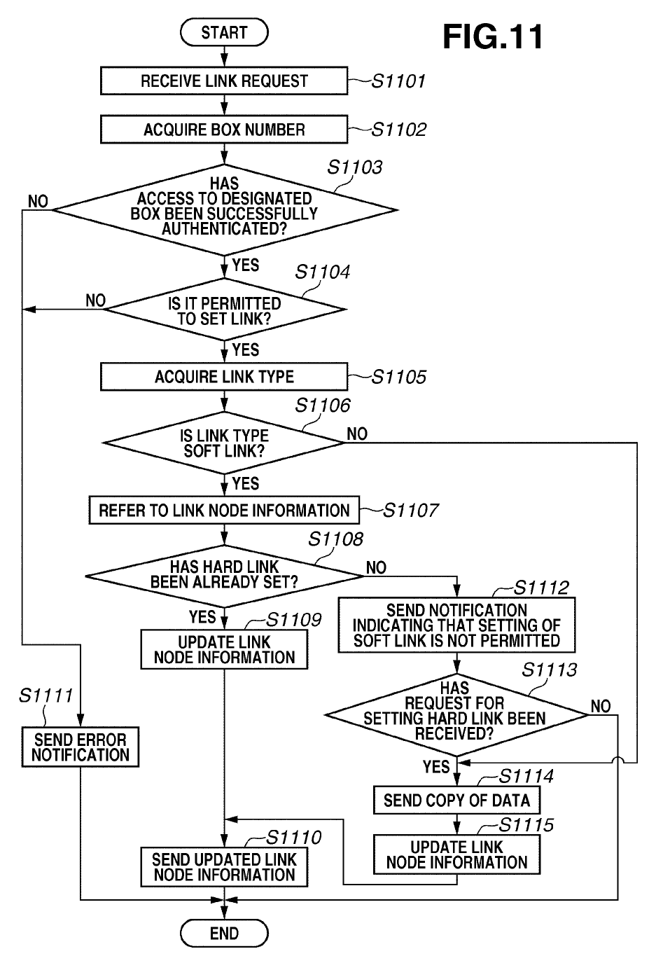

Now, an operation performed by the digital MFP 10 is described with reference to the flowchart of FIG. 11. The digital MFP 10 according to the present exemplary embodiment is a data processing apparatus that operates as the access destination apparatus that can allow the data stored therein to be referred to by the other apparatuses.

The flowchart illustrated in FIG. 11 illustrates an exemplary operation by the digital MFP 10 performed when the digital MFP 20 sends a link request to the digital MFP 10 as an example of a link request sending apparatus according to the present exemplary embodiment. Processing in each step of FIG. 11 is performed by executing a program stored on the ROM 103 with the CPU 101 of the controller 100 of the digital MFP 10.

Referring to FIG. 11, in step S1101, the LANC 105 receives a link request from the digital MFP 20 via a network. The link request includes path information for designating the data as a link target, a number of the box of the digital MFP 20, identification information (for example, the IP address) of the digital MFP 20, a password required to access the box, and information indicating the link type.

In step S1102, the CPU 101 refers to the path information included in the link request received in step S1101 to acquire the box number of the box storing the data designated as the link target. In addition, the CPU 101 acquires the password.

In step S1103, the CPU 101 uses the acquired password to perform an authentication as to whether the designated box can be accessed. If the access to the designated box has been successfully authenticated in step S1103 (YES in step S1103), then the processing advances to step S1104. If the access to the designated box has not been successfully authenticated in step S1103 (NO in step S1103), then the processing advances to step S1111.

Note here that in the case where no password is set for the box designated in the link request, the processing in step S1103 is skipped and the processing advances to step S1104. In step S1111, the CPU 101 generates error information indicating that the designated box has not been successfully authenticated and sends the error information to the digital MFP 20 via the LANC 105.

In step S1104, the CPU 101 refers to information indicating whether to permit the link included in the management information 3132 for the designated box and determines whether the link to the box can be set.

If it is determined in step S1104 that the link to the box can be set (YES in step S1104), then the processing advances to step S1105. On the other hand, if it is determined in step S1104 that the link to the box cannot be set (NO in step S1104), then the processing advances to step S1111.

Instep S1111, the CPU 101 generates error information indicating that the link to the box cannot be set and sends the error information to the digital MFP 20 via the LANC 105.

In step S1105, the CPU 101 acquires the information indicating the link type included in the link request received in step S1101. In step S1106, the CPU 101 determines whether the link type acquired in step S1105 is the soft link.

If it is determined in step S1106 that the link type acquired in step S1105 is the soft link (YES in step S1106), then, the processing advances to step S1107. On the other hand, if it is determined in step S1106 that the link type acquired in step S1105 is the hard link (NO in step S1106), then the processing advances to step S1114.

In step S1107, the CPU 101 refers to the link node information included in the management information 3132 for the designated box designated in the link request. In step S1108, the CPU 101 refers to the link node information and determines whether the hard link has already been set to the box.

If it is determined in step S1108 that the hard link has already been set to the box (YES in step S1108), then the processing advances to step S1109. On the other hand, if it is determined in step S1108 that the hard link has not been set to the box yet (NO in step S1108), then the processing advances to step S1112.

In step S1109, the CPU 101 sets the soft link to the data in the box designated in the link request. More specifically, the CPU 101 updates the link node information included in the management information 3132 for the designated box with the identification information of the digital MFP 20 (an IP address, for example) and the identification information indicating the soft link.

In step S1110, the CPU 101 sends the link node information updated in step S1109 to the digital MFP 20 via the LANC 105. Here, the information indicating that the link has been set based on the link request is sent at the same time. Furthermore, the CPU 101 also sends the updated link node information to the apparatuses other than the digital MFP 20 described in the link node information.

In step S1112, the CPU 101 generates information indicating that the soft link cannot be set and sends the information to the digital MFP 20 via the LANC 105.

In step S1113, the CPU 101 determines whether the link request for setting the hard link has been received from the digital MFP 20. If it is determined in step S1113 that no link request is received during a predetermined length of time period (NO in step S1113), then the CPU 101 ends the processing. On the other hand, if it is determined in step S1113 that the link request for setting the hard link has been received from the digital MFP 20 (YES in step S1113), then the processing advances to step S1114.

In step S1114, the CPU 101 sets the hard link to the data in the box designated in the link request.

More specifically, the CPU 101 generates a copy of the data stored in the box designated in the link request. Then, the CPU 101 sends the copy of the generated data to the digital MFP 20.

In step S1115, the CPU 101 updates the link node information included in the management information 3132 for the designated box with the identification information of the digital MFP 20 and the identification information for the hard link. Then, the processing advances to step S1110. In step S1110, the CPU 101 sends the updated link node information to the link request sending source apparatus.

As described above, the digital MFP 10, after receiving the link request, not only sets the link but also sends the link node information to the digital MFP 20, which is the link request sending source apparatus. The link node information includes information indicating what type of link is set to the data in the box designated in the link request.

The digital MFP 20 can recognize the setting status of the link to the data in the box to which the link has been set according to the received link node information. For example, the digital MFP 20 can recognize that another apparatus has set the hard link to the data.

Thus, if the entity of the data cannot be accessed due to a failure in the digital MFP 10 storing the data entity, the user can access and obtain a copy of the data from another apparatus that has set the hard link.

Furthermore, in the case where no hard link to the designated data has been set, the digital MFP 10, which is the access destination apparatus, does not set the soft link in response to the request for setting the soft link. More specifically, the digital MFP 10 performs control so that at least one hard link is always set in the case of setting the link to specific data.

Accordingly, in the case where the digital MFP 10 storing the entity of the data cannot be accessed, the copy of the data can be acquired from another apparatus that has set the hard link.

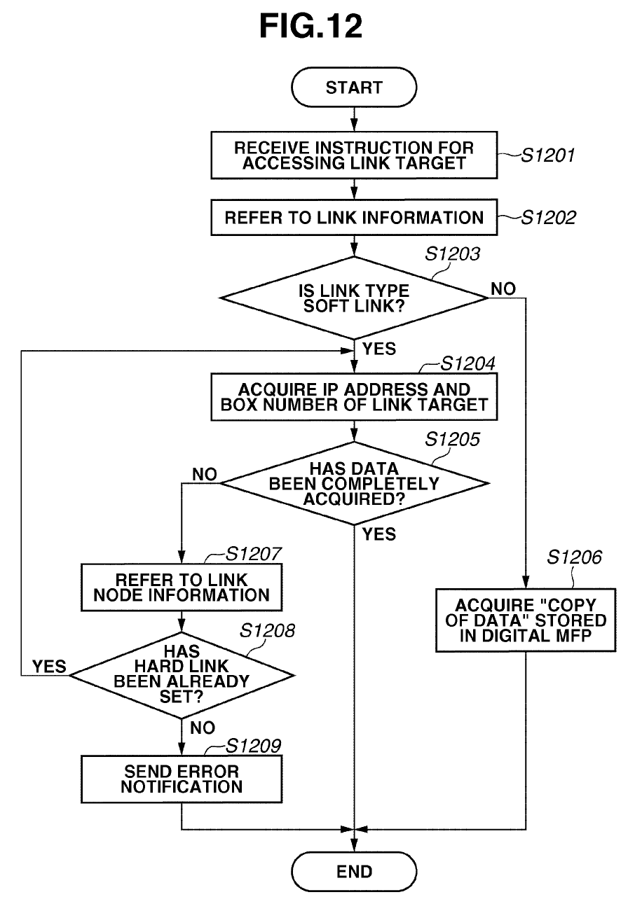

Now, an operation performed by the digital MFP 20 will be described in detail below with reference to the flowchart of FIG. 12.

The digital MFP 20 according to the present exemplary embodiment is a data processing apparatus that operates as the access source apparatus that sets the link to the data stored in the digital MFP 10 and refers to the data by using the set link.

The operation illustrated in FIG. 12 is performed by the digital MFP 20 in referring to the data by using the link after setting the same. Each step of FIG. 12 is performed by executing a program stored on the ROM 103 with the CPU 101 of the controller 100 of the digital MFP 20.

Referring to FIG. 12, in step S1201, the CPU 101 receives an instruction input by the user via the operation unit 180. The instruction received here is an instruction for performing processing on the data in an arbitrary box to which the link has been set. More specifically, the instruction received here is an instruction for referring to the data that is the link target.

After receiving the instruction, in step S1202, the CPU 101 refers to the link information 3214 stored in the selected box. In step S1203, the CPU 101 determines whether the link type is the soft link.

If it is determined in step S1203 that the link type is the soft link (YES in step S1203), then the processing advances to step S1204. On the other hand, if it is determined in step S1203 that the link type is the hard link (NO in step S1203), then the processing advances to step S1206.

In step S1204, the CPU 101 acquires the access destination IP address and information indicating a path to the data described in the link information 3214. Then, the CPU 101 accesses the link target data according to the acquired path information.

In step S1205, the CPU 101 determines whether the data has been acquired as a result of the access performed according to the information acquired in step S1204.

If it is determined in step S1205 that the data has been successfully acquired (YES in step S1205), then the processing ends. On the other hand, if it is determined in step S1205 that the data has not been successfully acquired (NO in step S1205), then the processing advances to step S1207.

Here, the data may not be successfully acquired due to the failure in the digital MFP 10, if the digital MFP 10 has been powered off, or if the digital MFP 10 has not been connected to the network.

In step S1207, the CPU 101 refers to the link node information 3260 in the link information 3214. In step S1208, the CPU 101 determines whether information indicating that the hard link has been set is included in the link node information.

If it is determined in step S1208 that the information indicating that the hard link has been set is included in the link node information (YES in step S1208), then the processing advances to step S1204. On the other hand, if it is determined in step S1208 that the information indicating that the hard link has been set is not included in the link node information (NO in step S1208), then the processing advances to step S1209.

In step S1204, the CPU 101 refers to the IP address and the information indicating a path to the copy of the data of the apparatus that has set the hard link.

In the example illustrated in FIG. 7, the CPU 101 refers to fields for a link node 2 and acquires the IP address “168.10.1.3” of the apparatus that has set the hard link and the path to the data “C/BOX00/SharedDocument”. Then, the CPU 101 accesses the access destination acquired via the LANC 105.

If the data (copy of the data) has been acquired as a result of the above-described processing, then the processing ends. On the other hand, if no data has been acquired, then the processing advances to step S1207 again.

On the other hand, if it is determined in step S1208 that the information indicating that the hard link has been set is not included in the link node information, then the processing advances to step S1209 as described above.

In step S1209, the CPU 101 generates error information indicating that no data has been acquired and displays the error information on the operation unit 180. Then, the processing ends.

Furthermore, if it is determined in step S1203 that the link type is the hard link (NO in step S1203), then the processing advances to step S1206. In step S1206, the CPU 101 acquires the copy of the data stored in the digital MFP 20 itself.

The digital MFP 20, which refers to the data according to the link set as described above, accesses the other apparatus or the storage unit of the digital MFP 20 according to the set link type to acquire the data.

Furthermore, when the data is acquired by accessing the other apparatus, if the data cannot be acquired from the other apparatus, the digital MFP 20 accesses another apparatus that stores the copy of the data. Accordingly, the present exemplary embodiment can increase the possibility of acquiring the data.

In this regard, the digital MFP 20 according to the present exemplary embodiment uses the link node information sent from the digital MFP 10 at the time of setting the link (step S1110 of FIG. 11).

By using the link node information, the digital MFP 20 can acquire a copy of the data from another apparatus even if the access to the entity of the data has failed (if the problem of broken link has occurred).

In the example illustrated in FIG. 11, it is necessary that the hard link has been already set to the data in setting the soft link to the data.

That is, the CPU 101 performs control so that at least one hard link is set to the data to which the link needs to be set. However, the processing in steps S1108, S1112, and S1113 can be omitted. That is, the hard link is cannot be always set.

In this case, if the apparatus storing the entity of the data cannot be accessed, the data cannot be acquired. However, with this configuration, the link type that the user desires to use can be prioritized.

A second exemplary embodiment of the present invention is described below. In the first exemplary embodiment described above, the control is performed so that at least one hard link is set to the data or the link type is determined by prioritizedly using the link type requested in the link request.

In this regard, in the present exemplary embodiment, the number of hard links to be set to the data that is the link target can be previously determined. That is, in the present exemplary embodiment, the link type is automatically determined according to the thus determined number of hard links to be set.

In the following description, a configuration of the second exemplary embodiment different from that of the first exemplary embodiment is primarily described. The system configuration and components of the apparatus according to the second exemplary embodiment are similar to those in the first exemplary embodiment. Accordingly, the description thereof will not be repeated here.

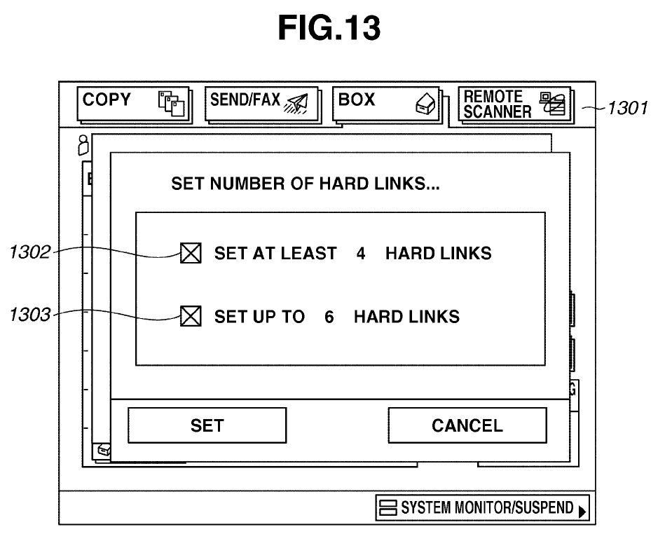

FIG. 13 illustrates an example of a screen 1301 displayed on the operation unit 180 of the digital MFP 10 according to the present exemplary embodiment. The screen 1301 illustrated in FIG. 13 is the screen via which the user enters the number of hard links to be set to the data stored in the digital MFP 10.

In the example illustrated in FIG. 13, the user enters four hard links at a minimum (field 1302) and six hard links at a maximum (field 1303) as the number of hard links to be set to the stored data.

In this case, the digital MFP 10 always sets the hard link until four hard links are set according to the link request to the data. Furthermore, the digital MFP 10 sets the soft link in response to the link request after setting of six or more hard links.

Note that the digital MFP 10 according to the present exemplary embodiment registers the setting value for the number of hard links input by the user via the screen illustrated in FIG. 13 and stores the registered number of hard links on the ROM 103.

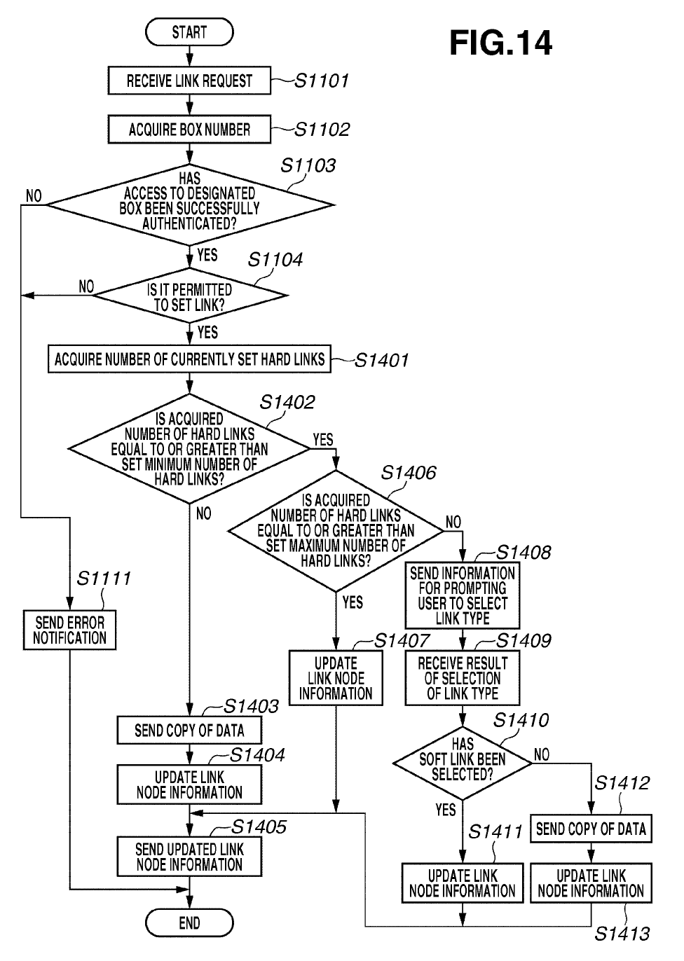

Now, an operation performed by the digital MFP 10 according to the present exemplary embodiment is described with reference to the flowchart illustrated in FIG. 14. The digital MFP 10 according to the present exemplary embodiment is a data processing apparatus that operates as the access destination apparatus that allows the other apparatus to refer to the data stored in the digital MFP 10.

The flowchart illustrated in FIG. 14 illustrates an exemplary operation performed by the digital MFP 10 when the digital MFP 20 sends a link request to the digital MFP 10 as an example of a link request sending apparatuses. Each step of FIG. 14 is performed by executing a program stored on the ROM 103 with the CPU 101 of the controller 100 of the digital MFP 10.

Note that the steps similar to those in the flowchart of FIG. 11 in the first exemplary embodiment are provided with the same step numbers as those in the first exemplary embodiment. The description of the processing in the steps similar to those in the first exemplary embodiment will not be repeated here. However, in the present exemplary embodiment, the information indicating the link type is not included in the link request received in step S1101.

The processing illustrated in FIG. 14 will now be described in detail below focusing on the processing different from that illustrated in FIG. 11.

If it is determined in step S1104 that the link can be set to the data in the box designated in the link request (YES in step S1104), then the processing advances to step S1401.

In step S1401, the CPU 101 refers to the management information 3132 for the designated box and acquires the number of hard links currently set to the designated data.

In step S1402, the CPU 101 reads a setting value for the number of hard links that has been previously set and stored on the ROM 103. Then, the CPU 101 determines whether the number of hard links acquired in step S1401 is equal to or greater than the number set as the minimum number of hard links.

If it is determined in step S1402 that the number of hard links acquired in step S1401 is smaller than the number set as the minimum number of hard links (NO in step S1402), then the processing advances to step S1403. In this regard, for example, if the minimum number of hard links has been set as illustrated in FIG. 13, the CPU 101 determines that the number of hard links acquired in step S1401 is smaller than the number set as the minimum number of hard links if the acquired number of hard links is three or less.

On the other hand, if it is determined in step S1402 that the number of hard links acquired in step S1401 is equal to or greater than the number set as the minimum number of hard links (YES in step S1402), then the processing advances to step S1406.

In step S1403, the CPU 101 sets the hard link to the data in the designated box. That is, the CPU 101 generates a copy of the data in the designated box and sends the copy of the data to the digital MFP 20 via the LANC 105. Then, the processing advances to step S1404.

In step S1404, the CPU 101 updates the link node information. In step S1405, the CPU 101 sends the updated link node information to the digital MFP 20 via the LANC 105.

In step S1406, the CPU 101 determines whether the number of hard links acquired in step S1401 is equal to or greater than the previously set maximum number of hard links. If it is determined in step S1406 that the number of hard links acquired in step S1401 is equal to or greater than the previously set maximum number of hard links (YES in step S1406), then the processing advances to step S1407. For example, in the case where the maximum number of hard links has been set as illustrated in FIG. 13, the CPU 101 determines that the number of hard links acquired in step S1401 is equal to or greater than the previously set maximum number of hard links if the number of hard links acquired in step S1401 is six or greater.

On the other hand, if it is determined in step S1406 that the number of hard links acquired in step S1401 is smaller than the maximum number of hard links (NO in step S1406), then the processing advances to step S1408. For example, in the case where the minimum number and the maximum number of hard links have been set as illustrated in FIG. 13, the CPU 101 determines that the number of hard links acquired in step S1401 is smaller than the maximum number of hard links if the number of hard links acquired in step S1401 is four or five.

In step S1407, the CPU 101 sets the soft link to the data in the designated box. That is, the CPU 101 updates the link node information.

In step S1405, the CPU 101 sends the updated link node information to the digital MFP 20 via the LANC 105.

In step S1408, the CPU 101 sends information for selecting the link type to the digital MFP 20.

After receiving the information for selecting the link type, the digital MFP 20 displays a screen for allowing the user to select which of the soft link and the hard link is to be used as the link type on the operation unit 180. The digital MFP 20 sends the link type selected according to the selection by the user to the digital MFP 10.

In step S1409, the LANC 105 receives a result of the selection of the link type from the digital MFP 20. In step S1410, the CPU 101 refers to the received result of the selection of the link type and determines which of the soft link and the hard link has been selected.

If it is determined in step S1410 that the soft link has been selected (YES in step S1410), then the processing advances to step S1411. In step S1411, the CPU 101 sets the soft link and updates the link node information. Instep S1405, the CPU 101 sends the updated link node information to the digital MFP 20 via the LANC 105.

On the other hand, if it is determined in step S1410 that the hard link has been selected (NO in step S1410), then the processing advances to step S1412. In step S1412, the CPU 101 generates a copy of the data in the designated box and sends the copy of the data to the digital MFP 20 via the LANC 105. Then, the processing advances to step S1413.

In step S1413, the CPU 101 updates the link node information. In step S1405, the CPU 101 sends the updated link node information to the digital MFP 20 via the LANC 105.

As described above, according to the present exemplary embodiment, if the link type is not selected on the link request sending source apparatus that sends the link request, the link type can be automatically determined according to the previously set setting value for the number of hard links.

Furthermore, according to the present exemplary embodiment, the user can previously designate the number of hard links to be generated.

That is, according to the present exemplary embodiment, if a large number of hard links are generated, the risk of coping with the problem of broken link can be suppressed or reduced. On the other hand, the load on the resource such as the memory increases because a large number of apparatuses store the copy of the data.

In this regard, if the number of hard links to be generated is small, the load on the resource can be reduced although the risk of coping with the problem of broken link can increase in this case. According to the present exemplary embodiment, the user can freely determine and designate the number of hard links to be generated according to the system status of the file system.

A third exemplary embodiment of the present invention is described below. In the above-described exemplary embodiments, it is presumed that the link request sending source apparatus, namely, the access source apparatus, can set the hard link. That is, it is presumed that the link request sending source apparatus includes a mass storage memory device having a relatively large storage capacity such as an HDD.

However, the soft link can be set to the access destination apparatus from the apparatus that does not include a mass storage memory device such as an HDD. In the present exemplary embodiment, the method for effectively setting the link in an environment in which an apparatus that includes a mass storage memory device such as an HDD and another apparatus that does not include any such memory device mixedly exist is described.

In the present exemplary embodiment, the system configuration and components of the apparatus are substantially similar to those in the first exemplary embodiment. Accordingly, the detailed description thereof will not be repeated here. However, among the digital MFPs 20 through 40 that set the link to the data stored in the digital MFP 10 to refer to the data includes an apparatus that does not include an HDD. The apparatus that does not include an HDD can set the soft link to the data stored in the digital MFP 10 but cannot set the hard link thereto.

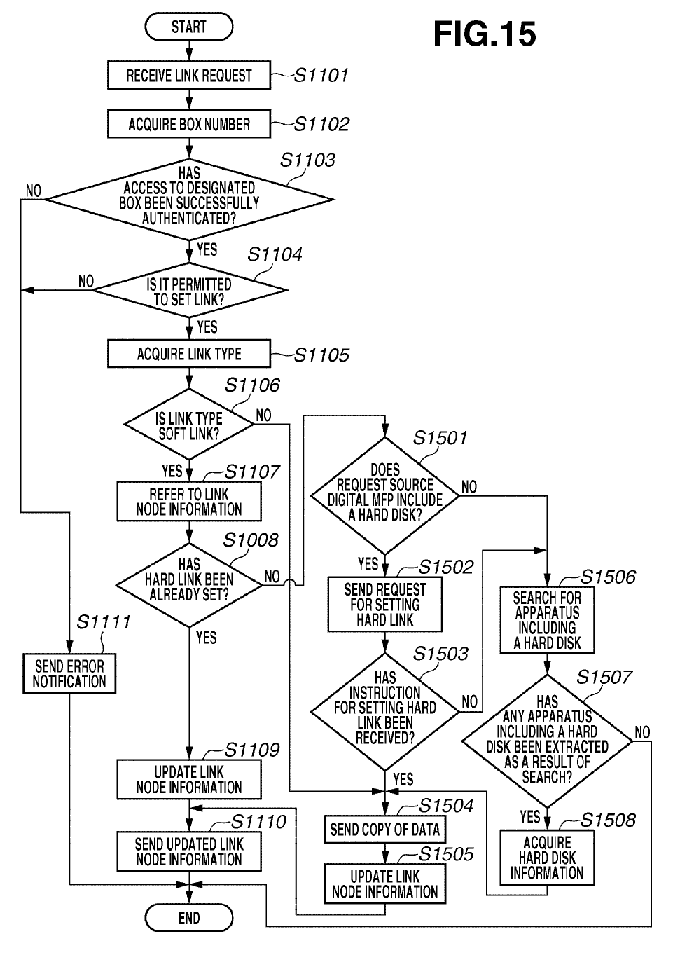

Now, an operation performed by the digital MFP 10 according to the present exemplary embodiment is described with reference to the flowchart illustrated in FIG. 15.

The digital MFP 10 according to the present exemplary embodiment is a data processing apparatus that operates as the access destination apparatus that allows the other apparatus to refer to the data stored in the digital MFP 10.

The flowchart illustrated in FIG. 15 illustrates an exemplary operation performed by the digital MFP 10 when the digital MFP 20 sends a link request to the digital MFP 10 as an example of a link request sending apparatuses. Each step of FIG. 15 is performed by executing a program stored on the ROM 103 with the CPU 101 of the controller 100 of the digital MFP 10. Note that the steps similar to those in the flowchart of FIG. 11 in the first exemplary embodiment are provided with the same step numbers as those in the first exemplary embodiment. The description of the processing in the steps similar to those in the first exemplary embodiment will not be repeated here.

If it is determined in step S1108 by referring to the link node information that the hard link has not been set to the box yet (NO in step S1108), then the processing advances to step S1501.

In step S1501, the CPU 101 determines whether the digital MFP 20 includes an HDD. More specifically, the CPU 101 sends information for inquiring of the digital MFP 20 whether the digital MFP 20 has an HDD via the LANC 105. The CPU 101 performs the determination according to a reply to the inquiry as to whether the digital MFP 20 includes an HDD.

If it is determined in step S1501 that the digital MFP 20 includes an HDD (YES in step S1501), then the processing advances to step S1502. On the other hand, if it is determined in step S1501 that the digital MFP 20 includes no HDD (NO in step S1501), then the processing advances to step S1506.

In step S1502, the CPU 101 sends a request for setting the hard link to the digital MFP 20. After receiving the request from the CPU 101 of the digital MFP 10, the digital MFP 20 displays a screen for prompting the user to designate whether to set the hard link as the link type and waits until the user enters the designation.

Then, the digital MFP 20 sends a result of the designation entered by user to the digital MFP 10. In step S1503, the CPU 101 determines whether a reply “yes” (“OK”) has been received as a reply to the request sent in step S1502.

If it is determined in step S1503 that the reply “OK” has been received, namely, if it is determined in step S1502 that an instruction for setting the hard link has been received from the digital MFP 20 (YES in step S1503), then the processing advances to step S1504.

On the other hand, if it is determined in step S1503 that a reply “OK” has not been received from the digital MFP 20 (NO in step S1503), then the processing advances to step S1506.

In step S1504, the CPU 101 sets the hard link to the data in the box designated in the link request. More specifically, the CPU 101 generates a copy of the data in the designated box and sends the copy of the data to the digital MFP 20 via the LANC 105.

In step S1505, the CPU 101 updates the link node information for the data in the designated box. In step S1110, the CPU 101 sends the updated link node information to the digital MFP 20 via the LANC 105.

If it is determined in step S1503 that a reply “OK” has not been received from the digital MFP 20 (NO in step S1503), then the processing advances to step S1506 as described above.

In step S1506, the CPU 101 searches for an apparatus including an HDD. More specifically, the CPU 101 broadcast-sends a network packet for inquiring whether an apparatus including an HDD exists to the network via the LANC 105.

With respect to a method for performing the search, a publicly known method, such as Simple Network Management protocol (SNMP) or Service Location Protocol (SLP), can be used. Furthermore, in the search in step S1506, a condition can be set so that only a digital MFP replies thereto can be set instead of the inquiry as to whether any apparatus including an HDD exists. Furthermore, in this regard, a setting can be performed so that only an apparatus connected to a predetermined specific apparatus is searched for instead of issuing the above-described inquiry.

In step S1507, the CPU 101 determines whether an apparatus including an HDD has been extracted as a result of search in step S1506. More specifically, the CPU 101 analyses the reply packet sent in response to the search packet sent in step S1506 and generates a list of apparatuses including an HDD.

Further, in step S1507, the CPU 101 determines whether at least one apparatus is included in the list of apparatuses including an HDD. If it is determined in step S1507 that an apparatus including an HDD has been extracted (YES in step S1507), then the processing advances to step S1508.

In step S1508, the CPU 101 arbitrarily selects one from among the apparatuses extracted in step S1506 and acquires hard disk information from the selected apparatus. Note that a method for arbitrarily selecting one apparatus is not particularly limited and any appropriate method can be used therefor.

The “hard disk information” is information for determining a data copy sending destination in the case of sending a copy of the data to set the hard link. More specifically, the hard disk information is structure information or free capacity information about the box. The CPU 101 arbitrarily selects a box according to the acquired hard disk information.

In step S1504, the CPU 101 sends the copy of the designated data to the selected box via the LANC 105. Then, the processing advances to step S1505. In step S1505, the CPU 101 updates the link node information.

Then, in step S1110, the CPU 101 sends the updated link node information to the digital MFP 20 via the LANC 105. Furthermore, here, the CPU 101 sends the updated link node information to not only the digital MFP 20 but also to the apparatus to which the hard link has been set.

According to the present exemplary embodiment having the above-described configuration, the link can be effectively set even if an apparatus that does not have a mass storage memory device, such as a hard disk, and thus cannot generate the hard link exists in the system.

If the apparatus that does not have a hard disk and thus can set only the soft link has generated the soft link, the present exemplary embodiment generates the hard link to the other apparatus to effectively cope with the problem of broken link.

Note that the timing for searching for an apparatus having a hard disk can be arbitrarily selected. In this regard, for example, it is also useful if the search over the network for an apparatus having a hard disk is performed when the digital MFP 10 is powered on, and the CPU 101 acquires information indicating whether each apparatus on the network has a hard disk from each apparatus and stores the information as a list.

The present invention can be applied to a system including a plurality of devices (for example, a computer, an interface device, a reader, a printer, a file server) and to an apparatus that includes one device (for example, a network MFP).

In the above-described exemplary embodiments of the present invention, the digital MFP 10 serves as the access destination apparatus and the digital MFP 20 serves as the access source apparatus. However, the present invention is not limited to this. That is, each of the digital MFPs 10 through 40 can operate as either the access source apparatus or the access destination apparatus. In addition, the data processing apparatus according to an exemplary embodiment of the present invention can include an information processing apparatus, such as a PC or a server, and a peripheral apparatus, such as a printer, scanner, or a facsimile, as well as the digital MFP.

Furthermore, the present invention can also be achieved by providing a system or a device with a storage medium (or a recording medium) which stores program code of software implementing the functions of the embodiments and by reading and executing the program code stored in the storage medium with a computer of the system or the device (a CPU or an MPU).

In this case, the program code itself, which is read from the storage medium, implements the functions of the embodiments mentioned above, and accordingly, the storage medium storing the program code constitutes the present invention.

As the storage medium for supplying such program code, a floppy disk, a hard disk, an optical disk, a magneto-optical disk (MO), a compact disc read-only memory (CD-ROM), a compact disc recordable (CD-R), a DVD-ROM, a magnetic tape, a nonvolatile memory card, or a ROM, for example, can be used.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-317280 filed Dec. 7, 2007, which is hereby incorporated by reference herein in its entirety.

What is claimed is:

1. A data processing apparatus comprising:
a data storage unit configured to store data;
an information storage unit configured to store identification information of an apparatus that has set a link to the data stored in the data storage unit and information indicating a link type of the link;
a reception unit configured to receive a link request for setting a link to the data stored in the data storage unit from another data processing apparatus;
a setting unit configured to set the link to the data stored in the data storage unit based on the link request received by the reception unit; and
a sending unit configured to send the information stored in the information storage unit to the another data processing apparatus according to the link being set by the setting unit.

2. The data processing apparatus according to claim 1, wherein the another data processing apparatus and an apparatus corresponding to the identification information stored in the information storage unit are different from each other.

3. The data processing apparatus according to claim 1, further comprising an updating unit configured to update the information stored in the information storage unit according to the link set by the setting unit,
wherein the sending unit is configured to send the information updated by the updating unit to the another data processing apparatus and an apparatus corresponding to the identification information stored in the information storage unit.

4. The data processing apparatus according to claim 1, further comprising a determination unit configured to determine a link type of the link to be set by the setting unit based on information indicating a link type previously stored in the information storage unit.

5. The data processing apparatus according to claim 1, wherein the information indicating the link type indicates which of a first link type for accessing the data stored in the data storage unit to refer to the data and a second link type in which the another data processing apparatus acquires a copy of the data stored in the data storage unit to refer to the copy is used as the link type.

6. The data processing apparatus according to claim 5, wherein the setting unit is configured to set the link based on the first link type if the information indicating the link type stored in the information storage unit indicates the second link type.

7. The data processing apparatus according to claim 5, wherein the setting unit is configured to set the link based on the second link type if the information storage unit does not store information indicating the second link type.

8. The data processing apparatus according to claim 5, further comprising a registration unit configured to register a value indicating a minimum number of links based on the second link type to be set to the data stored in the data storage unit,
wherein, if the number of links based on the second link type that have been already set to the data stored in the data storage unit is less than the value registered by the registration unit, the setting unit is configured to set the link based on the second link type.

9. The data processing apparatus according to claim 5, further comprising a registration unit configured to register a value indicating a maximum number of links based on the second link type to be set to the data stored in the data storage unit,
wherein, if the number of links based on the second link type that have been already set to the data stored in the data storage unit is equal to or greater than the value registered by the registration unit, the setting unit is configured to set the link based on the first link type.

10. The data processing apparatus according to claim 5, further comprising a searching unit configured to search for an apparatus capable of storing a copy of the data stored in the data storage unit if the information storage unit does not store information indicating the second link type and the another data processing apparatus is not capable of storing a copy of the data stored in the data storage unit,
wherein the setting unit is configured to set the link based on the second link type to an apparatus searched for by the searching unit and to set the link based on the first link type to the another data processing apparatus.

11. A method for controlling a data processing apparatus, the method comprising:
storing data in a data storage unit;
storing identification information of an apparatus that has set a link to the data stored in the data storage unit and information indicating a link type of the link;
receiving a link request for setting a link to the data stored in the data storage unit from another data processing apparatus;
setting the link to the data stored in the data storage unit based on the received link request; and
sending the stored information to the another data processing apparatus according to the link being set.

12. A computer-readable storage medium storing instructions which, when executed by a data processing apparatus, cause the data processing apparatus to perform operations comprising:
storing data in a data storage unit;
storing identification information of an apparatus that has set a link to the data stored in the data storage unit and information indicating a link type of the link;
receiving a link request for setting a link to the data stored in the data storage unit from another data processing apparatus;
setting the link to the data stored in the data storage unit based on the received link request; and
sending the stored information to the another data processing apparatus according to the link being set.
